(19) United States
(12) Patent Application Publication
(10) Pub. No.: US 2014/0169358 A1
(43) Pub. Date: Jun. 19, 2014

(54) Tracking And Messaging Based On Prior SSIDs Received

(71) Applicant: Naser Krasniqi, New City, NY (US)

(72) Inventor: Naser Krasniqi, New City, NY (US)

(21) Appl. No.: 14/188,082

(22) Filed: Feb. 24, 2014

(51) Int. Cl. H04W 4/12; H04W 48/10

(52) U.S. Cl. CPC H04W 4/12; H04W 48/10
USPC 370/338

(57) ABSTRACT

Wireless hand-held devices, such as cellular phones, with a second network capability, such as 802.11 network connectivity are used in the disclosed technology. These devices detect surrounding SSIDs (service side identification) transmitted from 802.11 networks, send the SSIDs to a server via the cellular connection, and receive back a message to be displayed. The message sent is dependent upon prior SSIDs detected and/or prior messages already sent. In embodiments, wireless transmitters which transmit SSIDs are of varying power, such that a stronger signal is detected in a broader area, and a weaker signal in a smaller area within the broader area. As such, locations and even paths of travel may be determined.

### FIELD OF THE DISCLOSED TECHNOLOGY

The disclosed technology relates generally to service set identification (SSID) of networks, and, more specifically, to tracking and messaging based on received SSIDs.

### BACKGROUND OF THE DISCLOSED TECHNOLOGY

Mobile phone technology has improved drastically to provide Internet access to a greater number of users. These devices typically may also connect to wireless data networks (such as 802.11 networks, known in the art for short range wireless communications) in addition to the cellular networks which typically rely on large transmission towers. The interplay of these two technologies allows for more accurate location determination of devices, when both the location of a wireless access point and location of a cellular tower are known. For purposes of this disclosure, a wireless access point refers to a device that broadcasts an SSID (service set identification). An SSID is defined as a wireless access point identifier which may be broadcast by an ad hoc network node, wireless router, or wireless hotspot, wireless access point or a mobile device or cell phone configured to broadcast a ssid. A “location” is a none limiter in space being within 1 meter, 10 meter, 100 meters, or 1000 meters of a specifically defined point or at an address or within a building.

For example, U.S. Pat. No. 7,787,887 to Gupta et al. discloses a location base service where ad-hoc wireless networks provide location information based on their SSIDs. U.S. Pat. No. 8,140,903 to Zaffino discloses using the SSID as a trigger to carry out an operation on a wireless device. U.S. Pat. No. 8,194,580 to McNew et al. similarly discloses conducting an operation in a software application based on receiving an SSID. Finally, U.S. Pat. No. 8,233,913 to Mendis discloses determining a location of a device based on a pattern and strength of wireless networks detected in the area.

Thus, in the present state of the art, the concept of using SSID's to determine location is known. However, a great deal more can be accomplished with this technology which has so far not been realized.

### SUMMARY OF THE DISCLOSED TECHNOLOGY

In an embodiment, a server having a processor which carries out instructions is used. The server is on a network node and receives location and SSID data for each of a plurality of wireless transmitters. That is, the location and the SSID are both known to the server. The location may be a room name within a building or a coordinate on the plane of the earth, and so forth. A hand-held wireless device with two network connections (such as an 802.11 network connection and a cellular data/IP network connection and/or phone network connection, whether through the IP network or otherwise) detects an SSID via one of the network connections. The processor then determines a message to be sent to the hand-held wireless device based on prior SSIDs received from the hand-held wireless device. If, in a group of pre-determined SSIDs (or those which must be sent/received in a specific order), this is the first such SSID sent (no other SSIDs in the group, or prior in the required order, have been received from this hand-held wireless device) then a first message is sent to the hand-held wireless device. If, however, a prior SSID has been received (in the group or required order), then a second message is sent. The message is transmitted via the network node to be exhibited on the hand-held wireless device.

In an embodiment, the second message displayed is based on at least two of the SSIDs received from two different wireless transmitters located within a building. The second of the two different wireless transmitters has a transmission power (maximum decibels) of less than 50%, 40%, 20%, or 10% of a first of the two different wireless transmitters. The message displayed is only displayed if the first wireless transmitter is detected before the second wireless transmitter is detected. The first message may be an instruction not to exhibit any message (or, the equivalent—the lack of a first message), whereas the second message may be an advertisement or inducement to make a purchase, and/or used as part of verification that a person/user and/or his device making a transaction is actually in a location where the transaction is being made. Either or both the first and second messages may be advertisements. Still further, detection of a first SSID may result in a message being sent, and detection of a second SSID may result in no message being sent, though the detection of the SSID is tracked and/or logged for later uses.

When an SSID is received, the transmitting of a message may be delayed to see if another SSID is received. This may be a delay of pre-defined period of time, such as 1, 5, 30, 60, 300, or 600 seconds. If another SSID is received (such as one having higher priority, and/or the next in an expected series, and/or one having lower power transmission indicating a more localized position of the hand-held wireless device, then a different message is displayed, based on the receipt of all SSIDs, or the last SSID.

In an example of the above, a first message is sent from the server when a pre-defined second SSID is received from the hand-held wireless device within the pre-defined period of time. Or, alternatively, a second message is sent from the server when the pre-defined second SSID is not received from the hand-held wireless device within said pre-defined period of time.

Data are further received via one, the other, or both network nodes, indicating that a monetary transaction has taken place between an owner of the hand-held wireless device and an operator of one of the wireless transmitters. These data may be used to effect a message sent concurrently with or after detection of another SSID by the hand-held wireless device and/or server. As such, a transaction may be further verified based on the detection of SSIDs and the order of detection. These data may be stored and later used to offer discounts to customers, or the like.

The step of determining which message to send, as carried out by the message server, may ignore SSIDs received which are outside of a geographic range specified by an operator of an associated wireless transmitter. The geographic range of the SSIDs is determined based on location information of the hand-held wireless device (such as determined based on GPS or prior SSIDs reported within a period of time) transmitted to the message server. This may further be used to detect fraudulent or rogue transmission of SSIDs and change the SSIDs of legitimate wireless transmitters.

Statistics may be generated, including any combination of a) all SSIDs received from all the hand-held wireless devices; b) number of second messages sent based on a received first message (that is, messages which are sent only when a specific prior SSID or one within a pre-defined group is detected); c) location of wireless transmitters associated with the SSIDs received; and/or d) monetary transaction amounts between owners of the wireless transmitters and owners of the hand-held wireless devices. These stats may be used to aid in further advertising or detection of fraud.

In a method of displaying messages, one associates a plurality of wireless transmitters with a server, wherein each wireless transmitter of said plurality thereof has an SSID. One further associates a plurality of hand-held wireless devices with the server, each one having its own associated identification, such as a unique identifier or user name/password credentials. Configuration instructions are received, configuring a message to be displayed on an end-user device based on detection of an SSID by the end-user device. Then, via a network node, information is received pertaining to real-time detecting of an SSID from a hand-held wireless device of the plurality thereof. Based on the configuration instructions, a message is selected for display, and this is sent via the network node (which includes another equivalent network node) to the hand-held wireless device.

The configuration instructions may include sending a first message if a first SSID is received from the hand-held wireless device. The instructions may also include a second message if a second SSID is received from the hand-held wireless device. Alternatively, a third message is sent if the second SSID is received within a pre-defined period of time after receiving the first SSID. That is, depending on whether the first SSID was received prior to the second SSID, the message sent and displayed on the hand-held wireless device will be different.

The first SSID may be associated with a first group of wireless transmitters selected from the group consisting of a single transmitter and/or a plurality of transmitters, and the second SSID may be associated with a second group of wireless transmitters selected from the group consisting of a single transmitter and/or a plurality of transmitters. The expected distance of transmission of the second group of wireless transmitters may be less than, or equal to, ½, ⅓, ¼, ⅕, ⅛, or 1/10 of the expected distance of transmission of said first group of wireless transmitters. The “expected distance” is defined as the geographic space in which it is expected that a hand-held wireless device will receive the SSID when scanning for SSIDs. The actual distance may be equal to the expected range, or may vary by up to 5, 10, 20, or 25%, depending on real world conditions. Further, the angle range of transmission may be less than 360 degrees. That is, the transmission may be directional, such as 1/12 of, or less, than the full circular direction (e.g. 30 degrees or less).

The step of sending may occur only if at least two pre-defined SSIDs are detected by the hand-held wireless device. The step of determining the message to be displayed may further take into account previous transactions between a person having operative control over a specific hand-held wireless device to which a message is being sent. As such, or in other eventualities, each of three hand-held wireless devices simultaneously (within a half-hour of each other) detecting an identical SSID, which is transmitted to them via the network node, may receive a different message to be displayed there-on.

The above-described method may be used as part of detection of illegal activity, including fraud and/or theft. Statistics may be generated regarding reported detection of SSIDs associated with the wireless transmitters, and the statistics may be sent to operators of the wireless transmitters. The statistics may be used to place markers on a map, including locations of the wireless transmitters and areas of detection thereof, along with paths of users detecting them and/or numbers of users at each location over a period of time.

The term “and/or” is defined to include both joined terms or either joined term. It should further be understood that the claim language should be read to be inclusive of either “receiving” or “sending,” such that if a term is used, a person is infringing if on the other side of the “receiving” or “sending.”

### BRIEF DESCRIPTION OF THE DRAWINGS

FIG. 1 shows a high-level block diagram of devices used to carry out embodiments of the disclosed technology.

FIG. 2 shows a high-level flow chart of steps carried out between a hand-held wireless device and server in embodiments of the disclosed technology.

FIG. 3 shows a high-level diagram of placement of wireless transmitters and hand-held wireless devices within a building.

FIG. 4 shows a high-level block diagram of a device that may be used to carry out the disclosed technology.

### DETAILED DESCRIPTION OF EMBODIMENTS OF THE DISCLOSED TECHNOLOGY

The disclosed technology described herein uses wireless hand-held devices, such as cellular phones, with a second network capability, such as 802.11 network connectivity. These devices detect surrounding SSIDs (service side identification) transmitted from 802.11 networks, send the SSIDs to a server via the cellular connection, and receive back a message to be displayed. The message sent is dependent upon prior SSIDs, if any, detected and/or prior messages already sent. In embodiments, wireless transmitters which transmit SSIDs are of varying power, such that a stronger signal is detected in a broader area, and a weaker signal in a smaller area within the broader area. As such, locations and even paths of travel may be determined.

The following disclosure, read in conjunction with the figures, will elucidate aspects of the disclosed technology.

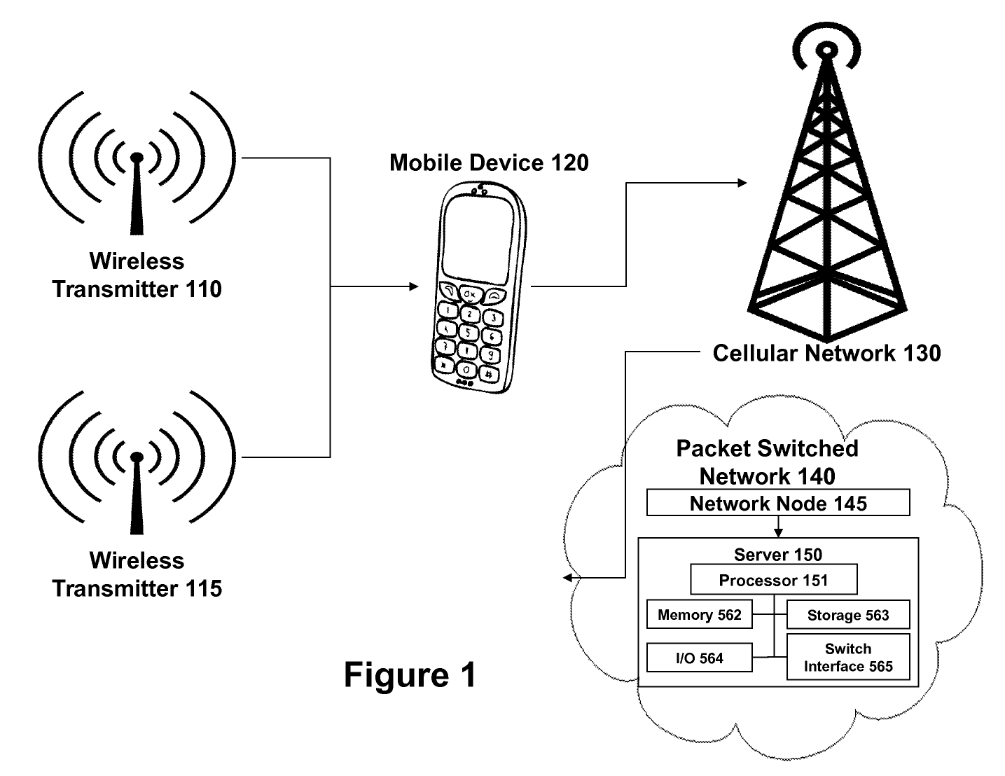

FIG. 1 shows a high-level block diagram of devices used to carry out embodiments of the disclosed technology. Wireless transmitter 110 and 115 broadcast SSIDs which are received by the mobile device 120. The mobile device 120 has at least two modes of wireless network communication—wifi (short range and designed to connect to an internet protocol packet-switched based network, based on, for example, the 802.11 protocol known in the art); and cellular. The cellular network is designed for long range voice and/or data communication via a cellular network with cellular towers (fixed location transceiver). Thus, the mobile device 120 has network connectivity with a cellular network 130, represented by the cellular tower shown in the figure. This cellular network connects via a packet-switched data network 140 to a network node 145 (defined as a physical point on the network on or through which data packets are received and acted upon and/or rebroadcast).

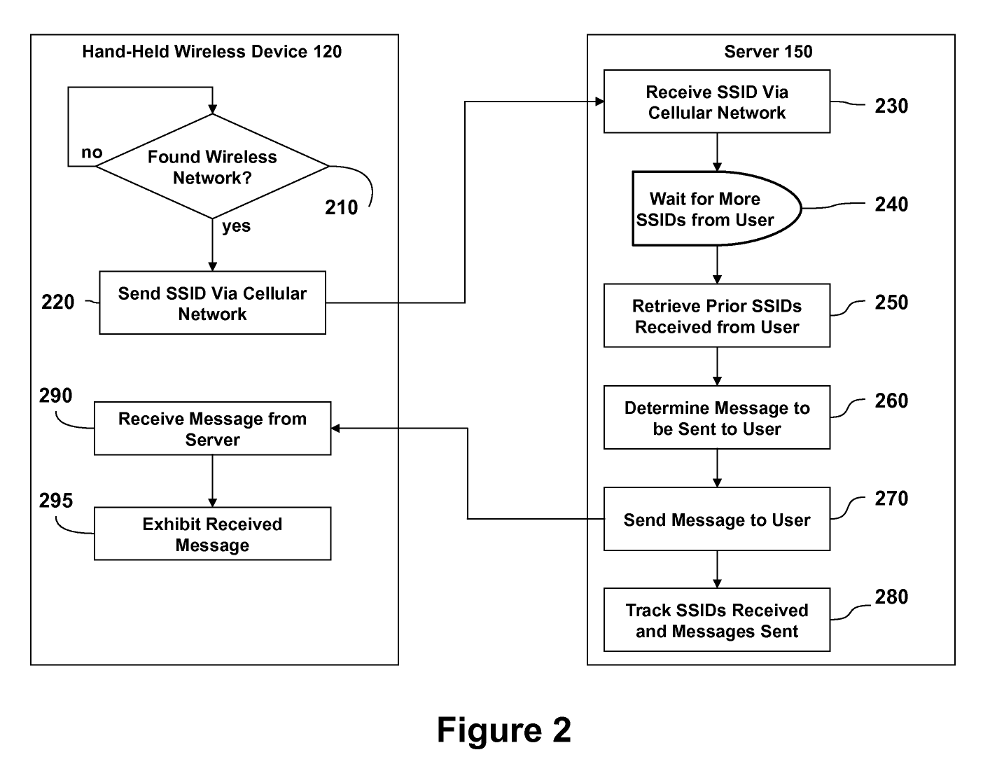

At the network node 145, data packets are forwarded to and from a server 150 having a processor 151, a device which receives and carries out instructions, memory 562 for storing data in the short term (volatile memory), storage 463 for storing data long term (non-volatile memory), an input/output 564 (such as keyboards, display devices, or the like), and switch interface 465 which receives and sends data to the network node 145. This server 150 receives from the mobile device 120 information representing SSID's received and then, based on the SSID's received, prior SSID's received, if any, and prior messages displayed to the mobile device 120, chooses and sends an appropriate new message to the mobile device 120 for display. The server 150 also stores tracking information, such as location data of mobile devices and which messages have been displayed. FIG. 2 shows these interactions in more detail.

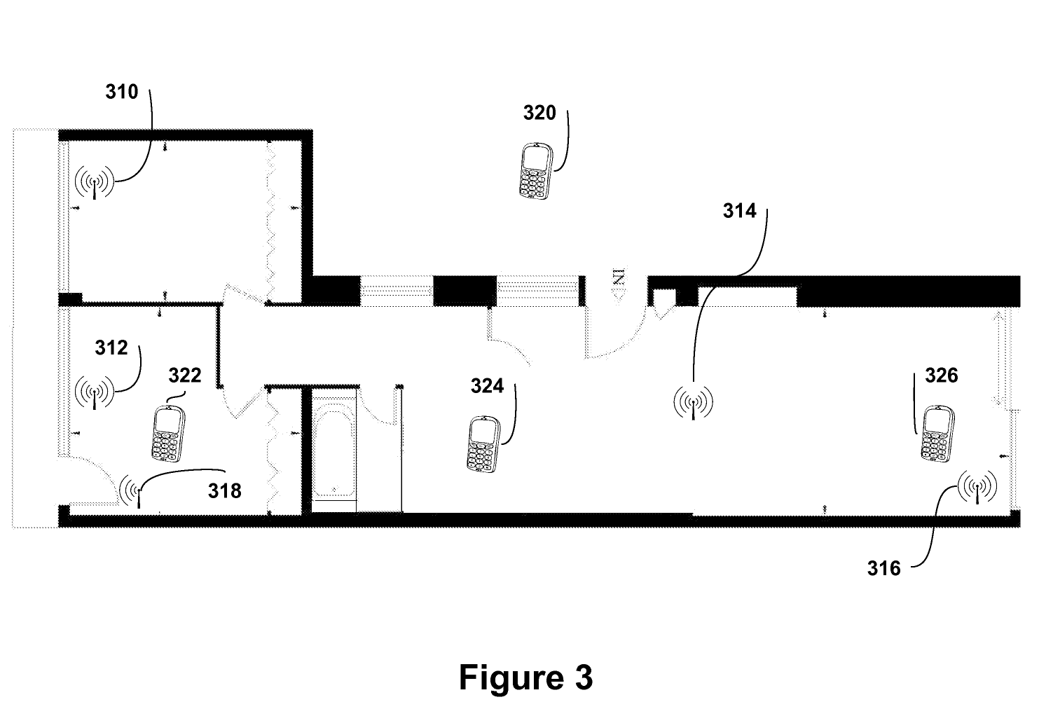

FIG. 2 shows a high-level flow chart of steps carried out between a hand-held wireless device and server, in embodiments of the disclosed technology. The hand-held wireless device or mobile device 120 constantly polls for wireless networks in the vicinity in step 210. When determining that a wireless network is found, the SSID is sent via the cellular network or other data network to the server 150. This server receives the SSID in step 230, and may wait to receive further SSIDs from the user (step 240) before acting. In this manner, as will become clearer with reference to FIG. 3, the server 150 may send a different message if multiple SSIDs are found within a short span of time, or one after the other, such as when a first SSID is detected upon entrance to a building, and a second SSID upon approaching a payment area. Now, it is known that the user not only entered the building, but actually went, for example, to the payment counter and had a greater interaction in a store than someone who merely entered and quickly left. Similarly, the longer the person remains, the longer the time the SSID will be detected. All this information is collated for tracking in step 280 where the SSIDs received are tracked.

Referring back to step 250, to determine what message is to be sent back to the user for display on his or her hand-held device 120, prior SSIDs and/or prior messages received from, or sent to, the wireless device 120 are retrieved. It should be understood that in this disclosure, the term “and/or” means any one of the listed items or more than one listed item. In step 260, the message to be sent to the user is then determined. This may be based on the progression or order of SSIDs received, and whether a prior message was already sent. For example, a prior message sent may be, “show this ad for $1 beers all night,” whereas, if such an ad was already shown, then the ad might be less generous. The repeat customer may be offered, “show this ad for one $1 beer.” Or, alternatively, “this is your 10^{th} time here. Have a free beer on the house with this ad!”

Once one of the messages is chosen, such as those listed in the prior paragraph, then in step 270 the message is sent to the user who receives it from the server in step 290. The message is exhibited on the handheld device in step 295. The ad may then be shown to the establishment or automatically used to provide a discount, such as along with a software payment application being executed on the hand-held wireless device 120.

FIG. 3 shows a high-level diagram of placement of wireless transmitters and hand-held wireless devices within a building. For purposes of the first part of the description, the building shown in FIG. 3 may be a bar. Various wifi transmitters broadcast SSIDs, including transmitters 310, 312, 314, and 316. A hand-held device may pick up any of these transmission signals. Such devices include device 320, 322, 324, and 326. For purposes of this description, suppose that each of these devices is actually a single device with changing position. Thus the device starts out at position 320 outside the building. Here, it receives an SSID from transmitter 314, and while carrying out the method shown in FIG. 2, transmits this SSID to a server which then transmits back a message, “come inside for a $1 beer!”. When the device is then in position 324, it additionally very weakly picks up the SSID for transmitter 312. As such, it is known that, once the device transmits this SSID to the server 150, the person holding the device 324 is inside the bar. The message sent back to the device may be, “Go to the far end of the bar for your $1drink.”

The transmitter 316 may purposely be designated as a very weak transmitter, such as transmitting at a strength of 5 db (decibels), or calibrated such that, for instance, device 326 will not pick up the SSID unless within 1, 2, or 3 meters and/or only when in a specific direction or at a specific side of the transmitter. As such, it is then known, based on the transmission of the SSID from the device 326 to the server 150, that the person has, in fact, gone to the back of the bar. Then, a message may be broadcast to the device noting, “Great! You have earned your $1 beer. Just purchase now—the offer expires in 15 minutes.”

Now, supposing that this same user comes back to the bar a second time. He enters through the entrance near transmitter 312 and is represented by the picture of device 322. Now the person might be told, based on a lookup of previous SSIDs sent to the server 150 by the handheld mobile device, “Welcome back! Enjoy 20% off your next food purchase.” Likewise, the message may change for each subsequent entry into the location, and a timer for the offer may count down from either the time a message is sent in response to the transmission of the SSID from transmitter 312, 314, and/or 316.

In another eventuality, let us suppose the device picks up transmitter 310 in a private room. This signal is stronger than any other at the device, or transmits so weakly that, if this signal is being picked up, we know that the device is in the room 310. If the person does not have authorization to be in this room, this may trigger an alarm, or the person might be sent a message, “Please leave this private room—security has been notified” or better, “stay where you are—your unauthorized entry has triggered the release of ravenous velociraptors. Running will only trigger a slower and more painful attack. Don't do it.” Unless, the person is, in fact, authorized, and then the message might be, “Welcome back, Jim.” That is, a person may be authorized based on the subsequent detection of various SSIDs, as well as movement logged.

In yet another eventuality, suppose a first user is standing at the position of device 326 when, on his friend's device, it shows, “$1 beer for you.” Now, this second person says to himself, that's great, I want to sign up for this service. Now, they are detected, for the first time, near the weakly transmitting transmitter 316. Even though this is this person's first time receiving the SSID, because the prior SSIDs received do not include the SSID from transmitters 320 or 322, the message sent may be different, such as, “Welcome to the bar. We appreciate your patronage. Buy something this time, and on your next visit you'll get 20% off.”

Referring still to FIG. 3, transmitter 318 is a directional transmitter. For purposes of this disclosure, a directional transmitter is one whose SSID is detectable within a 15, 45, 90, or 120 degree of transmission. The transmitter 318, as shown in FIG. 3, is transmitting only to the West (left of the page when viewed with the figure label at the bottom). Thus, a person who is walking in, out, or past the door to the west of the transmitter 318 will be able to pick up the SSID associated therewith. An advertisement, as described previously, may be sent based on this SSID and it will now be known, based on the SSID associated with the transmitter 318 received from hand-held wireless device of people using this system, who has simply walked past the door and who has actually walked in, based on further detection of another transmitter, such as transmitter 312 or 314 (assuming transmitter 312 does not transmit through the wall to the west of it).

As stated previously, a message need not be sent based on the detection of a transmitter (as reported by it's SSID being transmitted from a user device to a server processing same). The user may never realize this information is being tracked, but it may be used to change future messages sent when another SSID is detected, such as an SSID associated with transmitter 314 is detected. It may be known, for example, that person A walks past the store about 10 times for each time they enter, whereas person B enters every time they walk by. As such it can be gleaned that each person has very different habits with respect to the store, and may be sent very different types of advertising or coupons as a result.

Referring back to step 280 of FIG. 2, it should now be appreciated how the location tracking may be used for marketing purposes. In addition to providing people with incentives to transmit SSIDs to the server 150 (of FIG. 1), by giving them discounts and rewards, it is now known that when a person using such a system approaches a location, such as when transmitter 314's SSID is sent, or enters a location, such as when transmitter 312's SSID is sent as such, a transmitter may be calibrated or next to a wall which does not allow for transmission outside of the physical building in which it is located. For a given user, it may be known that, for example, he/she has passed by the location shown in FIG. 3 (at position 320) ten times and entered twice (at position 324), but only made a purchase once (at position 326 and combined with point of sale information).

Further, it may be determined which ads work best, based on where the user has previously been. Thus, for example, if a transmitter (such as transmitter 115) is placed in a park and another at a store, since the SSID related to the park was previously used, the store's associate SSID may result in a message being sent to a user having to do with an ad for soda. In another example, suppose a prior SSID received by a hand-held device was from a movie theater. Now, the store may offer the person a discount on merchandise related to a currently playing movie. Such an association may even be advertised to the user. For example, when leaving the theater, an SSID may be being detected at an exit near the time of the movie's ending. A message may then be displayed to the user, “Go to store X for a 20% discount off all movie Y merchandise.” When a person enters the store, he/she is offered the discount in a new message, whereas another person entering the store at the same time, and detecting the same SSID might be offered a different message, such as, “With purchase of $50 in movie Y merchandise, receive a free ticket to the see the movie.”

An “unsubscribe” function is also part of the disclosed technology. This allows a user to have his hand-held device 120 fail to report an SSID to the server 150 or fail to display a message associated therewith. This may be implemented for an individual SSID, for a group of SSIDs in a particular geographic area (when combined with GPS [global positioning system] data), or by a company owning SSIDs. For example, if the user does not want to receive any notifications from, or pertaining to, Brand X, then at all of Brand X's stores and associated transmitters (e.g., a transmitter 110 or 115) the device 120 of the user fails to report such SSIDs, based upon such SSIDs being provided from the server in advance, or upon detection of such an SSID. To avoid rogue SSID usage, positioning data may be used in conjunction. Thus, if an SSID is reported which matches that of a known transmitter, but the wireless device reports a location at a distance beyond the transmission range of the legitimate SSID transmission, then such an SSID may be ignored to prevent fraud.

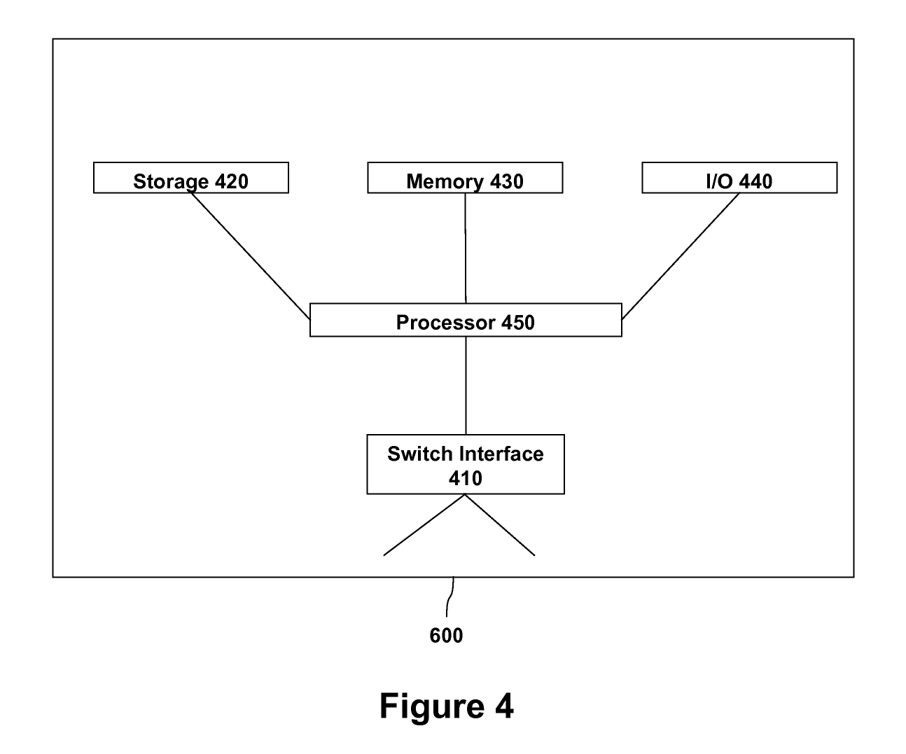

FIG. 4 shows a high-level block diagram of a device that may be used to carry out the disclosed technology. Device 400 comprises a processor 650 that controls the overall operation of the computer by executing the device's program instructions which define such operation. The device's program instructions may be stored in a storage device 420 (e.g., magnetic disk, database) and loaded into memory 430 when execution of the console's program instructions is desired. Thus, the device's operation will be defined by the device's program instructions stored in memory 430 and/or storage 620, and the console will be controlled by processor 450 executing the console's program instructions. A device 400 also includes one, or a plurality of, input network interfaces for communicating with other devices via a network (e.g., the Internet). The device 400 further includes an electrical input interface. A device 400 also includes one or more output network interfaces 410 for communicating with other devices. Device 400 also includes input/output 440 representing devices which allow for user interaction with a computer (e.g., display, keyboard, mouse, speakers, buttons, etc.). One skilled in the art will recognize that an implementation of an actual device will contain other components as well, and that FIG. 6 is a high level representation of some of the components of such a device for illustrative purposes. It should also be understood by one skilled in the art that the method and devices depicted in FIGS. 1 through 3 may be implemented on a device such as is shown in FIG. 4.

Further, it should be understood that all subject matter disclosed herein is directed at, and should be read only on, statutory, non-abstract subject matter. All terminology should be read to include only the portions of the definitions which may be claimed. By way of example, “computer readable storage medium” is understood to be defined as only non-transitory storage mediums.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

I claim:

1. A message server comprising:
a processor carrying out instructions;
a network node receiving location and SSID data for each of a plurality of wireless transmitters;
a network node receiving from a hand-held wireless device having two network connections, an SSID detected via a first of said two network connections;
wherein said processor determines a message to be sent to said hand-held wireless device based on prior SSIDs received from said hand-held wireless device, such that a first message is sent if no other SSIDs have been received from said hand-held wireless device from amongst a pre-defined subset of SSIDs, and a second message is sent if an SSID from said pre-defined subset of prior SSIDs has been received;
transmitting via said network node a message to be exhibited on said hand-held wireless device.

2. The message server of claim 1,
wherein said second message displayed is based on at least two said SSIDs received from two different wireless transmitters located within a building, of said plurality of wireless transmitters, wherein a second of said two different wireless transmitters has a transmission power of less than 20% of a first of said two different wireless transmitters, and said message is only displayed if said first wireless transmitter is detected before said second wireless transmitter.

3. The message server of claim 2, wherein said first message comprises instructions to exhibit no message to said hand-held wireless device.

4. The message server of claim 1, wherein said first message is an advertisement, and said second message is a further advertisement sent only if said first message was successfully exhibited on said hand-held wireless device.

5. The message server of claim 1, wherein, based on the SSID received, said transmitting is delayed for a pre-defined period of time pending receipt of further SSIDs from said hand-held wireless device.

6. The message server of claim 5, wherein a first message is sent from said server when a pre-defined second SSID is received from said hand-held wireless device within said pre-defined period of time, and a second message is sent from said server when said pre-defined second SSID is not received from said hand-held wireless device within said pre-defined period of time.

7. The message server of claim 4, wherein data are further received via either said network node, indicating that a monetary transaction has taken place between an owner of said hand-held wireless device and an operator of one of said wireless transmitters.

8. The message server of claim 7, wherein, when an SSID associated with said operator of said wireless transmitter is sent from said hand-held wireless device to said message server,
said message to be exhibited on said hand-held wireless device is modified based on said monetary transaction.

9. The message server of claim 1, wherein said step of determining carried out by said message server ignores SSIDs received which are outside of a geographic range specified by an operator of an associated said wireless transmitter, said geographic range of said SSIDs determined based on location information of said hand-held wireless device transmitted to said message server.

10. The message server of claim 1, wherein said processor is further instructed to generate statistics including at least three of the following:
all said SSIDs received from all said hand-held wireless devices;
number of said second messages sent based on a received said first message;
location of wireless transmitters associated with said SSIDs received;
monetary transaction amounts between owners of said wireless transmitters and owners of said hand-held wireless devices.

11. A method of displaying messages, comprising:
associating a plurality of wireless transmitters with a server, wherein each wireless transmitter of said plurality thereof has an SSID;
associating a plurality of hand-held wireless devices with said server; wherein each hand-held wireless device of said plurality thereof has an associated identification;
receiving configuration instructions for a message to be displayed on an end-user device based on detection of an SSID by said end-user device;
receiving, via a network node, information pertaining to real-time detecting of an SSID from a said hand-held wireless device of said plurality thereof;
determining, based on said configuration instructions, said message to be displayed; and
sending via said network node said message to be displayed on said hand-held wireless device.

12. The method of claim 11, wherein said configuration instructions comprise:
sending a first said message if a first said SSID is received from said hand-held wireless device;
sending a second said message if a second said SSID is received from said hand-held wireless device; and
sending a third said message if said second SSID is received from said hand-held wireless device within a pre-defined period of time after receiving said first SSID.

13. The method of claim 12, wherein:
said first SSID is associated with a first group of wireless transmitters selected from the group consisting of a single transmitter and a plurality of transmitters;
said second SSID is associated with a second group of wireless transmitters selected from the group consisting of a single transmitter and a plurality of transmitters;
and said expected distance of transmission of said second group of wireless transmitters is less than, or equal to, ⅕ of the expected distance of transmission of said first group of wireless transmitters.

14. The method of claim 11, wherein said step of sending occurs only if at least two pre-defined SSIDs are detected by said hand-held wireless device.

15. The method of claim 11, wherein said step of determining said message to be displayed further takes into account previous transactions between a person having operative control over said hand-held wireless device.

16. The method of claim 11, wherein each of three hand-held wireless devices simultaneously detecting a specific SSID (which is transmitted to said via said network node) receives a different message to be displayed there-on.

17. The method of claim 11, wherein transmission of said SSID from said hand-held wireless device is used to verify authenticity of a transaction by a user operating said hand-held wireless device.

18. The method of claim 11, wherein said method is used as part of detection of illegal activity including fraud and/or theft.

19. The method of claim 11, wherein statistics are generated regarding reported detection of SSIDs associated with said wireless transmitters, and said statistics are sent to operators of said wireless transmitters.

20. The method of claim 11, wherein said statistics are placed on a map with locations of said wireless transmitters indicating the path and/or number of users at each location over a period of time.

21. The method of claim 12, wherein:
said first SSID is associated with a first group of wireless transmitters selected from the group consisting of a single transmitter and a plurality of transmitters;
said second SSID is associated with a second group of wireless transmitters selected from the group consisting of a single transmitter and a plurality of transmitters;
and said expected direction of transmission of said second group of wireless transmitters is less than, or equal to, 1/12 of the expected range of transmission of said first group of wireless transmitters.

22. The method of claim 21, wherein said expected distance of transmission of said second group of wireless transmitters is less than, or equal to, ¼ of the expected distance of transmission of said first group of wireless transmitters.
